(19) United States
(12) Patent Application Publication
(10) Pub. No.: US 2005/0041735 A1
(43) Pub. Date: Feb. 24, 2005

(54) Moving image coding apparatus and method

(75) Inventor: Hideaki Shibata, Osaka (JP)

Correspondence Address: Jack Q. Lever, Jr.;McDERMOTT, WILL & EMERY, 600 Thirteenth Street, N.W., Washington, DC, 20005-3096, US

(73) Assignee: MATSUSHITA ELECTRIC INDUSTRIAL CO., LTD.

(21) Appl. No.: 10/827,383

(22) Filed: Apr. 20, 2004

(30) Foreign Application Priority Data
Aug. 19, 2003 (JP) 2003-295594

(51) Int. Cl. H04N 7/12

(52) U.S. Cl. 375/240.01

(57) ABSTRACT

A moving image coding method includes a first coding section, a decoding section and a second coding section. The first coding section compression-codes a moving image signal in a first time (T) and outputs the results as a coded moving image signal of a first information amount (V), and also obtains control information. The decoding section decodes the coded moving image signal coded by the first coding section and outputs the results as a decoded moving image signal. The second coding section compression-codes the decoded moving image signal from the decoding section based on the control information obtained by the first coding section and a set second information amount (R) and outputs the results as a coded moving image signal of the second information amount (R). The control information includes: the first information amount (V); a plurality of second times (Tr) obtained by dividing the first time (T); and a third information amount (Vi) as the information amount of a coded moving image signal output from the first coding section during each of the plurality of second times (Tr).

### BACKGROUND OF THE INVENTION

The present invention relates to an apparatus and method for coding a moving image, and more particularly, to an apparatus and method for decoding a compression-coded moving image signal and then compression-coding the decoded signal again.

Conventionally, as such a moving image coding apparatus and method, in which a moving image signal is compression-coded and recorded in a recording medium, the coded moving image signal is then decoded, and the decoded signal is compression-coded again, the apparatus disclosed in Japanese Laid-Open Patent Publication No. 11-313331 is known.

In FIG. 1 of the publication No. 11-313331, an MPEG decoder 10 decodes an MPEG-coded bit stream and outputs the decoded moving image signal to a multiplexer 11. The MPEG decoder 10 also extracts coding parameters such as the coded bit amount and/or the average quantization scale and outputs the results to the multiplexer 11 and a switch 16. The multiplexer 11 multiplexes the decoded moving image signal and the extracted coding parameters received from the MPEG decoder 10, and outputs the results to a recording/playback system 12 as a moving image signal. Receiving the multiplexed signal, a separator 13 separates the decoded moving image signal and the coding parameters from each other, and outputs the decoded moving image signal to an MPEG encoder 14 and the coding parameters to the switch 16. The switch 16 selects between the coding parameters directly output from the MPEG decoder 10 and the coding parameters that has passed through the recording/playback system 12 and been separated by the separator 13, and outputs the results to the MPEG encoder 14. The MPEG encoder 14 performs re-compression coding using the coding parameters used in the first coding.

In the re-compression coding of the decoded moving image signal using representative values of the coding parameters (coded bit amount, average quantization scale and the like) described above, the representative values of the coding parameters given to the MPEG encoder 14 during the re-compression coding merely represent information at the present time (that is, of the current picture, slice or the like). Conventionally, therefore, it is impossible to determine whether in the entire moving image, for which coding is to be performed, an image scene just to be coded is a scene difficult in coding or a scene easy in coding. Accordingly, although the conventional technique permits control of the coded information amount in picture units, slice units or the like, it does not permit optimum control of the coded information amount for the entire decoded moving image signal. In the apparatus having the above construction, it is possible to perform such control of the coded information amount that makes the total coded information amount in the initial compression coding (first coding) and the coded information amount in the re-compression coding (second coding) agree with each other. However, optimum control may fail when it is desired to change the total coded information amount generated after compression coding between the first coding and the second coding, like reducing the total coded information amount in the second coding from the total coded information amount in the first coding.

### SUMMARY OF THE INVENTION

An object of the present invention is providing an apparatus and method that can perform optimum control of the coded information amount for the entire decoded moving image signal in re-compression coding.

According to one aspect of the invention, the moving image coding apparatus includes a first coding section, a decoding section and a second coding section. The first coding section compression-codes a moving image signal in a first time (T) and outputs the results as a coded moving image signal of a first information amount (V), and also obtains control information. The decoding section decodes the coded moving image signal compression-coded by the first coding section and outputs the results as a decoded moving image signal. The second coding section compression-codes the decoded moving image signal from the decoding section based on the control information obtained by the first coding section and a set second information amount (R) and outputs the results as a coded moving image signal of the second information amount (R). The control information includes: the first information amount (V); a plurality of second times (Tr) obtained by dividing the first time (T); and a third information amount (Vi) as the information amount of a coded moving image signal output from the first coding section during each of the plurality of second times (Tr).

In the moving image coding apparatus described above, as the third information amount (Vi) is larger in a given second time (Tr), this second time is a time in which the coding is more difficult. In other words, the third information amount (Vi) indicates the degree of difficulty of coding. The second coding section performs control based on the control information so that the information amount of a new coded moving image signal to be output from the second coding section matches with the set second information amount (R). The second coding section therefore can perform the control of the information amount over the entire decoded moving image signal, for which compression coding is to be performed, while considering the degree of difficulty of coding. In this way, temporal control can be made for the information amount of a new coded moving image signal to be output from the second coding section, and thus it is possible to attain compression coding (second coding) by the second coding section close to the compression coding (first coding) by the first coding section. In other words, degradation in quality due to re-coding can be reduced. Also, even when the performance on the control of the information amount in the second coding is somewhat inferior to that in the first coding, control conforming to the performance on the control of the information amount in the first coding is ensured in the second coding.

Preferably, the first coding section includes a third coding section and a total coded amount calculation section. The third coding section compression-codes the moving image signal in the first time (T) and outputs the results as the coded moving image signal of the first information amount (V), and also obtains the second time (Tr) and the third information amount (Vi). The total coded amount calculation section calculates the first information amount (V) using the third information amount (Vi) obtained by the third coding section. The second coding section compression-codes the decoded moving image signal from the decoding section based on the second time (Tr) and the third information amount (Vi) obtained by the third coding section, the first information amount (V) obtained by the total coded amount calculation section, and the set second information amount (R), and outputs the results as the coded moving image signal of the second information amount (R).

In the moving image coding apparatus described above, as the third information amount (Vi) is larger in a given second time (Tr), this second time is a time in which the coding is more difficult. In other words, the third information amount (Vi) indicates the degree of difficulty of coding. The second coding section performs control based on the control information so that the information amount of a new coded moving image signal to be output from the second coding section matches with the set second information amount (R). The second coding section therefore can perform the control of the information amount over the entire decoded moving image signal, for which compression coding is to be performed, while considering the degree of difficulty of coding. In this way, temporal control can be made for the information amount of a new coded moving image signal to be output from the second coding section, and thus it is possible to attain compression coding (second coding) by the second coding section close to the compression coding (first coding) by the first coding section. In other words, degradation in quality due to re-coding can be reduced. Also, even if the performance on the control of the information amount in the second coding is somewhat inferior to that in the first coding, control conforming to the performance on the control of the information amount in the first coding is ensured in the second coding. In addition, since the total coded amount calculation section calculates the first information amount (V), the amount of information obtained as the control information can be reduced, in comparison with the case of obtaining the first information amount (V) as control information. For example, when the control information is stored in a recording medium, the capacity for this recording can be reduced.

Preferably, the second coding section outputs a coded moving image signal of a fourth information amount (Ri) during each of the plurality of second times (Tr). The fourth information amount (Ri) is obtained by calculating Ri=Vi×R/V using the first information amount (V), the second information amount (R) and the third information amount (Vi).

In the moving image coding apparatus described above, as the third information amount (Vi) is larger in a given second time (Tr), this second time (Tr) is a time in which the coding is more difficult. In other words, the third information amount (Vi) indicates the degree of difficulty of coding. The second coding section outputs the coded moving image signal of the fourth information amount (Ri) in the second time (Tr) by calculating the above expression (Ri=Vi×R/V). By outputting the coded moving image signal of the fourth information amount (Ri) every second time (Tr), the second coding section outputs the coded moving image signal of the second information amount (R). In this way, temporal control can be made for the information amount of a new coded moving image signal to be output from the second coding section, and thus it is possible to attain compression coding (second coding) by the second coding section close to the compression coding (first coding) by the first coding section. In other words, degradation in quality due to re-coding can be reduced. Also, even if the performance on the control of the information amount in the second coding is somewhat inferior to that in the first coding, control conforming to the performance on the control of the information amount in the first coding is ensured in the second coding.

According to another aspect of the invention, the moving image coding apparatus includes a first coding section, a decoding section and a second coding section. The first coding section compression-codes a moving image signal in a first time (T) and outputs the results as a coded moving image signal of a first information amount (V), and also obtains control information. The decoding section decodes the coded moving image signal compression-coded by the first coding section and outputs the results as a decoded moving image signal. The second coding section compression-codes the decoded moving image signal from the decoding section based on the control information obtained by the first coding section and a set second information amount (R), and outputs the results as a coded moving image signal of the second information amount (R). The control information includes: a plurality of second times (Ti); and a number (X) of the second times (Ti), the plurality of second times (Ti) correspond to a plurality of third information amounts (Vr) obtained by dividing the first information amount (V). Each of the plurality of second times (Ti) represents the time required for a coded moving image signal of the corresponding third information amount (Vr) to be output from the first coding section.

In the moving image coding apparatus described above, as the second time (Ti) is shorter, the information amount of the coded moving image signal output per unit time during the second time is larger. In other words, a shorter second time (Ti) is a time in which the compression coding is more difficult, and thus the second time (Ti) indicates the degree of difficulty of coding. The second coding section performs control based on the control information so that the information amount of a new coded moving image signal to be output from the second coding section matches with the set second information amount (R). The second coding section therefore can control the information amount over the entire decoded moving image signal, for which compression coding is to be performed, while considering the degree of difficulty of coding. In this way, temporal control can be made for the information amount of a new coded moving image signal to be output from the second coding section, and thus it is possible to attain compression coding (second coding) by the second coding section close to the compression coding (first coding) by the first coding section. In other words, degradation in quality due to re-coding can be reduced. Also, even if the performance on the control of the information amount in the second coding is somewhat inferior to that in the first coding, control conforming to the performance on the control of the information amount in the first coding is ensured in the second coding.

Preferably, the second coding section includes a third coding section and a number count section. The third coding section compression-codes the moving image signal in the first time (T) and outputs the results as the coded moving image signal of the first information amount (V), and also obtains the second time (Ti). The number count section counts the number (X) of the second times (Ti) obtained by the third coding section. The second coding section compression-codes the decoded moving image signal from the decoding section based on the second time (Ti) obtained by the third coding section, the number (X) obtained by the number count section, and the set second information amount (R), and outputs the results as the coded moving image signal of the second information amount (R).

In the moving image coding apparatus described above, as the second time (Ti) is shorter, the information amount of the coded moving image signal output per unit time during the second time is larger. In other words, a shorter second time (Ti) is a time in which the compression coding is more difficult, and thus the second time (Ti) indicates the degree of difficulty of coding. The second coding section performs control based on the control information so that the information amount of a new coded moving image signal to be output from the second coding section matches with the set second information amount (R). The second coding section therefore can control the information amount over the entire decoded moving image signal, for which compression coding is to be performed, while considering the degree of difficulty of coding. In this way, temporal control can be made for the information amount of a new coded moving image signal to be output from the second coding section, and thus it is possible to attain compression coding (second coding) by the second coding section close to the compression coding (first coding) by the first coding section. In other words, degradation in quality due to re-coding can be reduced. Also, even if the performance on the control of the information amount in the second coding is somewhat inferior to that in the first coding, control conforming to the performance on the control of the information amount in the first coding is ensured in the second coding. In addition, since the number counter counts the number X of the second times (Ti), the amount of information obtained as the control information can be reduced, in comparison with the case of obtaining the number X as control information. For example, when the control information is stored in a recording medium, the capacity for the recording can be reduced.

Preferably, the second coding section outputs a coded moving image signal of a fourth information amount (Rr) during each of the plurality of second times (Ti). The fourth information amount (Rr) is obtained by calculating Rr=R/X using the number (X) and the second information amount (R).

In the moving image coding apparatus described above, as the second time (Ti) is shorter, the information amount of the coded moving image signal output per unit time during the second time is larger. In other words, a shorter second time (Ti) is a time in which the compression coding is more difficult, and thus the second time (Ti) indicates the degree of difficulty of coding. The second coding section outputs the coded moving image signal of the fourth information amount (Rr) every second time (Ti) by calculating the above expression (Rr=R/X). By outputting the coded moving image signal of the fourth information amount (Ri) every second time (Ti), the second coding section outputs the coded moving image signal of the second information amount (R). In this way, temporal control can be made for the information amount of a new coded moving image signal to be output from the second coding section, and thus it is possible to attain compression coding (second coding) by the second coding section close to the compression coding (first coding) by the first coding section. In other words, degradation in quality due to re-coding can be reduced. Also, even if the performance on the control of the information amount in the second coding is somewhat inferior to that in the first coding, control conforming to the performance on the control of the information amount in the first coding is ensured in the second coding.

According to yet another aspect of the invention, the moving image coding apparatus includes a first coding section. The first coding section compression-codes a moving image signal in a first time (T) and outputs the results as a coded moving image signal of a first information amount (V), and also obtains control information. The control information includes: a plurality of second times (Tr) obtained by dividing the first time (T); and a third information amount (Vi) as the information amount of a coded moving image signal output from the first coding section during each of the plurality of second times (Tr).

In the moving image coding apparatus described above, as the third information amount (Vi) is larger in a given second time (Tr), this second time (Tr) is a time in which the coding is more difficult. In other words, the third information amount (Vi) indicates the degree of difficulty of coding. By using the control information in re-coding, it is possible to control the information amount over the entire decoded moving image signal, for which compression coding is to be performed, while considering the degree of difficulty of coding. In this way, temporal control can be made for the information amount of a new coded moving image signal to be output after the re-coding, and thus it is possible to attain re-coding (second coding) close to the compression coding (first coding) by the first coding section. In other words, degradation in quality due to the re-coding can be reduced. Also, even if the performance on the control of the information amount in the second coding is somewhat inferior to that in the first coding, control conforming to the performance on the control of the information amount in the first coding is ensured in the second coding.

According to yet another aspect of the invention, the moving image coding apparatus is an apparatus for processing a signal including a compression-coded moving image signal (coded moving image signal) and control information. The coded moving image signal is obtained by compression-coding a moving image signal in a first time (T) to give a first information amount (V). The control information includes: the first information amount (V) of the coded moving image signal; a plurality of second times (Tr) obtained by dividing the first time (T); and a third information amount (Vi) as the information amount of a moving image signal output during each of the plurality of second times (Tr) in the compression coding of the coded moving image signal. The apparatus includes a decoding section and a second coding section. The decoding section decodes the coded moving image signal and outputs the results as a decoded moving image signal. The second coding section compression-codes the decoded moving image signal from the decoding section based on the control information and a set second information amount (R) and outputs the results as a coded moving image signal of the second information amount (R).

In the moving image coding apparatus described above, as the third information amount (Vi) is larger in a given second time (Tr), this second time (Tr) is a time in which the coding is more difficult. In other words, the third information amount (Vi) indicates the degree of difficulty of coding. The second coding section performs control based on the control information so that the information amount of a new coded moving image signal to be output from the second coding section matches with the set second information amount (R). The second coding section therefore can control the information amount over the entire decoded moving image signal, for which compression coding is to be performed, while considering the degree of difficulty of coding. In this way, temporal control can be made for the information amount of a new coded moving image signal to be output from the second coding section, and thus it is possible to attain compression coding (second coding) by the second coding section close to the compression coding (first coding) by the first coding section. In other words, degradation in quality due to re-coding can be reduced. Also, even if the performance on the control of the information amount in the second coding is somewhat inferior to that in the first coding, control conforming to the performance on the control of the information amount in the first coding is ensured in the second coding.

According to yet another aspect of the invention, the moving image coding apparatus includes a first coding section. The first coding section compression-codes a moving image signal in a first time (T) and outputs the results as a coded moving image signal of a first information amount (V), and also obtains control information. The control information includes a plurality of second times (Ti). The plurality of second times (Ti) correspond to a plurality of third information amounts (Vr) obtained by dividing the first information amount (V). Each of the plurality of second times (Ti) represents the time required for a coded moving image signal of the corresponding third information amount (Vr) to be output from the first coding section.

In the moving image coding apparatus described above, as the second time (Ti) is shorter, the information amount of the coded moving image signal output per unit time during the second time is larger. In other words, a shorter second time (Ti) is a time in which the compression coding is more difficult, and thus the second time (Ti) indicates the degree of difficulty of coding. By using the control information in re-compression coding, it is possible to control the information amount over the entire decoded moving image signal, for which compression coding is to be performed, while considering the degree of difficulty of coding. In this way, temporal control can be made for the information amount of a new coded moving image signal to be output after the re-coding, and thus it is possible to attain re-compression coding (second coding) close to the compression coding (first coding) by the first coding section. In other words, degradation in quality due to the re-coding can be reduced. Also, even if the performance on the control of the information amount in the second coding is somewhat inferior to that in the first coding, control conforming to the performance on the control of the information amount in the first coding is ensured in the second coding.

According to yet another aspect of the invention, the moving image coding apparatus is an apparatus for processing a signal including a compression-coded moving image signal (coded moving image signal) and control information. The coded moving image signal is obtained by compression-coding a moving image signal in a first time (T) to give a first information amount (V). The control information includes: a plurality of second times (Ti); and a number (X) of the second times (Ti). The plurality of second times (Ti) correspond to a plurality of third information amounts (Vr) obtained by dividing the first information amount (V). Each of the plurality of second times (Ti) represents the time required for a coded moving image signal of the corresponding third information amount (Vr) to be output in the compression coding of the coded moving image signal. The apparatus includes a decoding section and a second coding section. The decoding section decodes the coded moving image signal and outputs the results as a decoded moving image signal. The second coding section compression-codes the decoded moving image signal from the decoding section based on the control information and a set second information amount (R) and outputs the results as a coded moving image signal of the second information amount (R).

In the moving image coding apparatus described above, as the second time (Ti) is shorter, the information amount of the coded moving image signal output per unit time during the second time is larger. In other words, a shorter second time (Ti) is a time in which the compression coding is more difficult, and thus the second time (Ti) indicates the degree of difficulty of coding. The second coding section performs control based on the control information so that the information amount of a new coded moving image signal to be output from the second coding section matches with the set second information amount (R). The second coding section therefore can control the information amount over the entire decoded moving image signal, for which compression coding is to be performed, while considering the degree of difficulty of coding. In this way, temporal control can be made for the information amount of a new coded moving image signal to be output from the second coding section, and thus it is possible to attain compression coding (second coding) by the second coding section close to the compression coding (first coding) by the first coding section. In other words, degradation in quality due to re-coding can be reduced. Also, even if the performance on the control of the information amount in the second coding is somewhat inferior to that in the first coding, control conforming to the performance on the control of the information amount in the first coding is ensured in the second coding.

Preferably, the second information amount (R) is smaller than the first information amount (V).

According to yet another aspect of the present invention, the moving image coding method includes a first coding step, a decoding step and a second coding step. The first coding step includes compression-coding a moving image signal in a first time (T) and outputting the results as a coded moving image signal of a first information amount (V), and also obtaining control information. The decoding step includes decoding the coded moving image signal compression-coded in the first coding step and outputting the results as a decoded moving image signal. The second coding step includes compression-coding the decoded moving image signal obtained in the decoding step based on the control information obtained in the first coding step and a set second information amount (R) and outputting the results as a coded moving image signal of the second information amount (R). The control information includes: the first information amount (V); a plurality of second times (Tr) obtained by dividing the first time (T); and a third information amount (Vi) as the information amount of a coded moving image signal output in the first coding step during each of the plurality of second times (Tr).

In the moving image coding method described above, as the third information amount (Vi) is larger in a given second time (Tr), this second time (Tr) is a time in which the coding is more difficult. In other words, the third information amount (Vi) indicates the degree of difficulty of coding. In the second coding step, control is performed based on the control information so that the information amount of a new coded moving image signal to be output in the second coding step matches with the set second information amount (R). In the second coding step, therefore, it is possible to control the information amount over the entire decoded moving image signal, for which compression coding is to be performed, while considering the degree of difficulty of coding. In this way, temporal control can be made for the information amount of a new coded moving image signal to be output in the second coding step, and thus it is possible to attain compression coding (second coding) in the second coding step close to the compression coding (first coding) in the first coding step. In other words, degradation in quality due to re-coding can be reduced. Also, even if the performance on the control of the information amount in the second coding is somewhat inferior to that in the first coding, control conforming to the performance on the control of the information amount in the first coding is ensured in the second coding.

Preferably, the first coding step includes a third coding step and a total coded amount calculation step. The third coding step includes compression-coding the moving image signal in the first time (T) and outputting the results as the coded moving image signal of the first information amount (V), and also obtaining the second time (Tr) and the third information amount (Vi). The total coded amount calculation step includes calculating the first information amount (V) using the third information amount (Vi) obtained in the third coding step. In the second coding step, the decoded moving image signal obtained in the decoding step is compression-coded based on the second time (Tr) and the third information amount (Vi) obtained in the third coding step, the first information amount (V) obtained in the total coded amount calculation step, and the set second information amount (R), and the results are output as the coded moving image signal of the second information amount (R).

In the moving image coding method described above, as the third information amount (Vi) is larger in a given second time (Tr), this second time (Tr) is a time in which the coding is more difficult. In other words, the third information amount (Vi) indicates the degree of difficulty of coding. In the second coding step, control is performed based on the control information so that the information amount of a new coded moving image signal to be output in the second coding step matches with the set second information amount (R). In the second coding step, therefore, it is possible to control the information amount over the entire decoded moving image signal, for which compression coding is to be performed, while considering the degree of difficulty of coding. In this way, temporal control can be made for the information amount of a new coded moving image signal to be output in the second coding step, and thus it is possible to attain compression coding (second coding) in the second coding step close to the compression coding (first coding) in the first coding step. In other words, degradation in quality due to re-coding can be reduced. Also, even if the performance on the control of the information amount in the second coding is somewhat inferior to that in the first coding, control conforming to the performance on the control of the information amount in the first coding is ensured in the second coding. In addition, since the first information amount (V) is calculated in the total coded amount calculation step, the amount of information obtained as the control information can be reduced, in comparison with the case of obtaining the first information amount (V) as control information. For example, when the control information is stored in a recording medium, the capacity for the recording can be reduced.

Preferably, in the second coding step, a coded moving image signal of a fourth information amount (Ri) is output during each of the plurality of second times (Tr). The fourth information amount (Ri) is obtained by calculating Ri=Vi×R/V using the first information amount (V), the second information amount (R) and the third information amount (Vi).

In the moving image coding method described above, as the third information amount (Vi) is larger in a given second time (Tr), this second time (Tr) is a time in which the coding is more difficult. In other words, the third information amount (Vi) indicates the degree of difficulty of coding. In the second coding step, the coded moving image signal of the fourth information amount (Ri) obtained by calculating the above expression (Ri=Vi×R/V) is output in the second time (Tr). In the second coding step, by outputting the coded moving image signal of the fourth information amount (Ri) every second time (Tr), the coded moving image signal of the second information amount (R) is output. In this way, temporal control can be made for the information amount of a new coded moving image signal to be output in the second coding step, and thus it is possible to attain compression coding (second coding) in the second coding step close to the compression coding (first coding) in the first coding step. In other words, degradation in quality due to re-coding can be reduced. Also, even if the performance on the control of the information amount in the second coding is somewhat inferior to that in the first coding, control conforming to the performance on the control of the information amount in the first coding is ensured in the second coding.

According to yet another aspect of the invention, the moving image coding method includes a first coding step, a decoding step and a second coding step. The first coding step includes compression-coding a moving image signal in a first time (T) and outputting the results as a coded moving image signal of a first information amount (V), and also obtaining control information. The decoding step includes decoding the coded moving image signal compression-coded in the first coding step and outputting the results as a decoded moving image signal. The second coding step includes compression-coding the decoded moving image signal obtained in the decoding step based on the control information obtained in the first coding step and a set second information amount (R) and outputting the results as a coded moving image signal of the second information amount (R). The control information includes a plurality of second times (Ti) and a number (X) of the second times (Ti). The plurality of second times (Ti) correspond to a plurality of third information amounts (Vr) obtained by dividing the first information amount (V). Each of the plurality of second times (Ti) represents the time required for a coded moving image signal of the corresponding third information amount (Vr) to be output in the first coding step.

In the moving image coding method described above, as the second time (Ti) is shorter, the information amount of the coded moving image signal output per unit time during the second time is larger. In other words, a shorter second time (Ti) is a time in which the compression coding is more difficult, and thus the second time (Ti) indicates the degree of difficulty of coding. In the second coding step, control is performed based on the control information so that the information amount of a new coded moving image signal to be output in the second coding step matches with the set second information amount (R). In the second coding step, therefore, it is possible to control the information amount over the entire decoded moving image signal, for which compression coding is to be performed, while considering the degree of difficulty of coding. In this way, temporal control can be made for the information amount of a new coded moving image signal to be output in the second coding step, and thus it is possible to attain compression coding (second coding) in the second coding step close to the compression coding (first coding) in the first coding step. In other words, degradation in quality due to re-coding can be reduced. Also, even if the performance on the control of the information amount in the second coding is somewhat inferior to that in the first coding, control conforming to the performance on the control of the information amount in the first coding is ensured in the second coding.

Preferably, the second coding step includes a third coding step and a number count step. The third coding step includes compression-coding a moving image signal in the first time (T) and outputting the results as the coded moving image signal of the first information amount (V), and also obtaining the second time (Ti). The number count step includes counting the number (X) of the second times (Ti) obtained in the third coding step. In the second coding step, the decoded moving image signal obtained in the second coding step is compression-coded based on the second time (Ti) obtained in the third coding step, the number (X) obtained in the number count step, and the set second information amount (R), and the results are output as the coded moving image signal of the second information amount (R).

In the moving image coding method described above, as the second time (Ti) is shorter, the information amount of the coded moving image signal output per unit time during the second time is larger. In other words, a shorter second time (Ti) is a time in which the compression coding is more difficult, and thus the second time (Ti) indicates the degree of difficulty of coding. In the second coding step, control is performed based on the control information so that the information amount of a new coded moving image signal to be output in the second coding step matches with the set second information amount (R). In the second coding step, therefore, it is possible to control the information amount over the entire decoded moving image signal, for which compression coding is to be performed, while considering the degree of difficulty of coding. In this way, temporal control can be made for the information amount of a new coded moving image signal to be output in the second coding section, and thus it is possible to attain compression coding (second coding) in the second coding section close to the compression coding (first coding) in the first coding section. In other words, degradation in quality due to re-coding can be reduced. Also, even if the performance on the control of the information amount in the second coding is somewhat inferior to that in the first coding, control conforming to the performance on the control of the information amount in the first coding is ensured in the second coding. In addition, since the number X of the second times (Ti) is counted in the number count step, the amount of information obtained as the control information can be reduced, in comparison with the case of obtaining the number X as control information. For example, when the control information is stored in a recording medium, the capacity for the recording can be reduced.

Preferably, in the second coding step, a coded moving image signal of a fourth information amount (Rr) is output during each of the plurality of second times (Ti), and the fourth information amount (Rr) is obtained by calculating Rr=R/X using the number (X) and the second information amount (R).

In the moving image coding method described above, as the second time (Ti) is shorter, the information amount of the coded moving image signal output per unit time during the second time is larger. In other words, a shorter second time (Ti) is a time in which the compression coding is more difficult, and thus the second time (Ti) indicates the degree of difficulty of coding. In the second coding step, the coded moving image signal of the fourth information amount (Rr) obtained by calculating the above expression (Rr=R/X) is output every second time (Ti). In the second coding step, by outputting the coded moving image signal of the fourth information amount (Rr) every second time (Ti), the coded moving image signal of the second information amount (R) is output. In this way, temporal control can be made for the information amount of a new coded moving image signal to be output in the second coding step, and thus it is possible to attain compression coding (second coding) in the second coding step close to the compression coding (first coding) in the first coding section. In other words, degradation in quality due to re-coding can be reduced. Also, even if the performance on the control of the information amount in the second coding is somewhat inferior to that in the first coding, control conforming to the performance on the control of the information amount in the first coding is ensured in the second coding.

According to yet another aspect of the invention, the moving image coding method includes a first coding step. The first coding step includes compression-coding a moving image signal in a first time (T) and outputting the results as a coded moving image signal of a first information amount (V), and also obtaining control information. The control information includes: a plurality of second times (Tr) obtained by dividing the first time (T); and a third information amount (Vi) as the information amount of a coded moving image signal output in the first coding step during each of the plurality of second times (Tr).

In the moving image coding method described above, as the third information amount (Vi) is larger in a given second time (Tr), this second time (Tr) is a time in which the coding is more difficult. In other words, the third information amount (Vi) indicates the degree of difficulty of coding. By using the control information in re-coding, it is possible to control the information amount over the entire decoded moving image signal, for which compression coding is to be performed, while considering the degree of difficulty of coding. In this way, temporal control can be made for the information amount of a new coded moving image signal to be output after the re-coding, and thus it is possible to attain re-coding (second coding) close to the compression coding (first coding) in the first coding step. In other words, degradation in quality due to the re-coding can be reduced. Also, even if the performance on the control of the information amount in the second coding is somewhat inferior to that in the first coding, control conforming to the performance on the control of the information amount in the first coding is ensured in the second coding.

According to yet another aspect of the invention, the moving image coding method is a method for processing a signal including a compression-coded moving image signal (coded moving image signal) and control information. The coded moving image signal is obtained by compression-coding a moving image signal in a first time (T) to give a first information amount (V). The control information includes: the first information amount (V) of the coded moving image signal; a plurality of second times (Tr) obtained by dividing the first time (T); and a third information amount (Vi) as the information amount of a moving image signal output during each of the plurality of second times (Tr) in the compression coding of the coded moving image signal. The method includes a decoding step and a second coding step. The decoding step includes decoding the coded moving image signal and outputting the results as a decoded moving image signal. The second coding step includes compression-coding the decoded moving image signal obtained in the decoding step based on the control information and a set second information amount (R) and outputting the results as a coded moving image signal of the second information amount (R).

In the moving image coding method described above, as the third information amount (Vi) is larger in a given second time (Tr), this second time (Tr) is a time in which the coding is more difficult. In other words, the third information amount (Vi) indicates the degree of difficulty of coding. In the second coding step, control is performed based on the control information so that the information amount of a new coded moving image signal to be output in the second coding step matches with the set second information amount (R). In the second coding step, therefore, it is possible to control the information amount over the entire decoded moving image signal, for which compression coding is to be performed, while considering the degree of difficulty of coding. In this way, temporal control can be made for the information amount of a new coded moving image signal to be output in the second coding step, and thus it is possible to attain compression coding (second coding) in the second coding step close to the compression coding (first coding) in the first coding section. In other words, degradation in quality due to re-coding can be reduced. Also, even if the performance on the control of the information amount in the second coding is somewhat inferior to that in the first coding, control conforming to the performance on the control of the information amount in the first coding is ensured in the second coding.

According to yet another aspect of the invention, the moving image coding method includes a first coding step. The first coding step includes compression-coding a moving image signal in a first time (T) and outputting the results as a coded moving image signal of a first information amount (V), and also obtaining control information. The control information includes a plurality of second times (Tr). The plurality of second times (Ti) correspond to a plurality of third information amount (Vr) obtained by dividing the first information amount (V). Each of the plurality of second times (Ti) represents the time required for a coded moving image signal of the corresponding third information amount (Vr) to be output in the first coding step.

In the moving image coding apparatus described above, as the second time (Ti) is shorter, the information amount of the coded moving image signal output per unit time during the second time is larger. In other words, a shorter second time (Ti) is a time in which the compression coding is more difficult, and thus the second time (Ti) indicates the degree of difficulty of coding. By using the control information in re-compression coding, it is possible to control the information amount over the entire decoded moving image signal, for which compression coding is to be performed, while considering the degree of difficulty of coding. In this way, temporal control can be made for the information amount of a new coded moving image signal to be output after the re-coding, and thus it is possible to provide re-compression coding (second coding) close to the compression coding (first coding) in the first coding section. In other words, degradation in quality due to the re-coding can be reduced. Also, even if the performance on the control of the information amount in the second coding is somewhat inferior to that in the first coding, control conforming to the performance on the control of the information amount in the first coding is ensured in the second coding.

According to yet another aspect of the invention, the moving image coding method is a method for processing a signal including a compression-coded moving image signal (coded moving image signal) and control information. The coded moving image signal is obtained by compression-coding a moving image signal in a first time (T) to give a first information amount (V). The control information includes a plurality of second times (Ti) and a number (X) of the second times (Ti). The plurality of second times (Ti) correspond to a plurality of third information amounts (Vr) obtained by dividing the first information amount (V). Each of the plurality of second times (Ti) represents the time required for a coded moving image signal of the corresponding third information amount (Vr) to be output in the compression coding of the coded moving image signal. The method includes a decoding step and a second coding step. The decoding step includes decoding the coded moving image signal and outputting the results as a decoded moving image signal. The second coding step includes compression-coding the decoded moving image signal obtained in the decoding step based on the control information and a set second information amount (R) and outputting the results as a coded moving image signal of the second information amount (R).

In the moving image coding method described above, as the second time (Ti) is shorter, the information amount of the coded moving image signal output per unit time during the second time is larger. In other words, a shorter second time (Ti) is a time in which the compression coding is more difficult, and thus the second time (Ti) indicates the degree of difficulty of coding. In the second coding step, control is performed based on the control information so that the information amount of a new coded moving image signal to be output in the second coding step matches with the set second information amount (R). Therefore, in the second coding step, it is possible to control the information amount over the entire decoded moving image signal, for which compression coding is to be performed, while considering the degree of difficulty of coding. In this way, temporal control can be made for the information amount of a new coded moving image signal to be output in the second coding step, and thus it is possible to attain compression coding (second coding) in the second coding step close to the compression coding (first coding) in the first coding step. In other words, degradation in quality due to re-coding can be reduced. Also, even if the performance on the control of the information amount in the second coding is somewhat inferior to that in the first coding, control conforming to the performance on the control of the information amount in the first coding is ensured in the second coding.

Preferably, the second information amount (R) is smaller than the first information amount (V).

As described above, according to the present invention, the coded information amount of a decoded moving image signal, for which coding is to be performed, in each local time interval can be controlled using information on the decoded moving image signal in the entire playback display time interval. Accordingly, the present invention can provide an advantageous effect that efficient, high-quality re-compression coding is attained when it is intended to change the total information amount generated after compression coding between the re-compression coding and the first compression coding.

### BRIEF DESCRIPTION OF THE DRAWINGS

FIG. 1 is a block diagram showing the overall configuration of a moving image coding apparatus of Embodiment 1 of the present invention.

FIGS. 2A to 2D are views showing an example of change of data with operation of the moving image coding apparatus of FIG. 1.

FIG. 3 is a block diagram showing the overall configuration of a moving image coding apparatus of Embodiment 2 of the present invention.

FIG. 4 is a block diagram showing the overall configuration of a moving image coding apparatus of Embodiment 3 of the present invention.

FIGS. 5A to 5D are views showing an example of change of data with operation of the moving image coding apparatus of FIG. 4.

FIG. 6 is a block diagram showing the overall configuration of a moving image coding apparatus of Embodiment 4 of the present invention.

### DESCRIPTION OF THE PREFERRED EMBODIMENTS

Hereinafter, preferred embodiments of the present invention will be described with reference to the accompanying drawings.

(Embodiment 1)

<Overall Configuration>

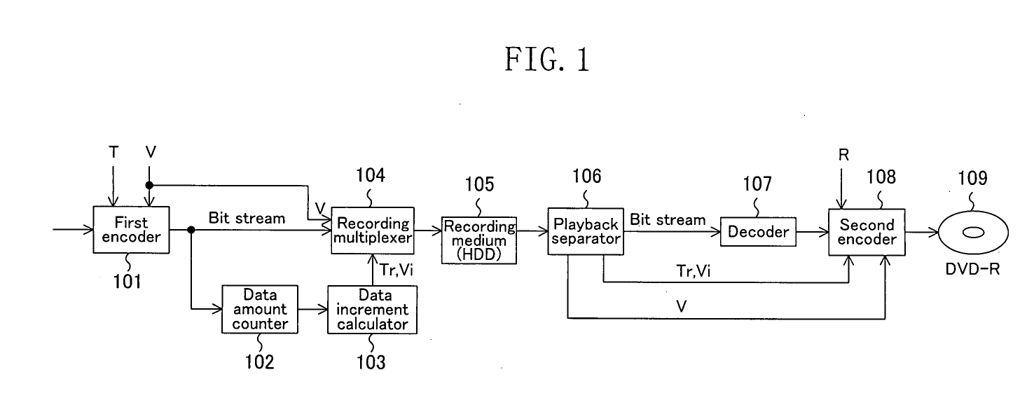

FIG. 1 shows the overall configuration of a moving image coding apparatus of Embodiment 1 of the present invention, which is an apparatus (for example, a HDD-embedded DVD video recorder) for compression-coding a moving image signal recorded in a compression-coded state in a temporary recording medium (for example, a hard disk) and recording the compression-coded image in a recording medium for storage (for example, a DVD-R). The apparatus includes a first encoder 101, a data amount counter 102, a data increment calculator 103, a recording multiplexer 104, a recording medium (for example, a hard disk) 105, a playback separator 106, a decoder 107 and a second encoder 108. The first encoder 101 compression-codes an input moving image signal in a total input time T based on a total coded information amount V, and outputs the results as a bit stream (coded moving image signal). The data amount counter 102 counts the number of bits of the bit stream. The data increment calculator 103 calculates an increment VI of bits of a bit stream counted by the data amount counter 102 in each predetermined time interval Tr (calculates coded information amount of the bit stream output from the first encoder 101 in each predetermined time interval Tr). The recording multiplexer 104 multiplexes the data output from the blocks (the bit stream and the control information (V, Tr, Vi)) into a form suitable for the format and the like of the recording medium 105, and records the resultant data in the recording medium 105. The playback separator 106 plays back and separates the bit stream and the control information (V, Tr, Vi) from the data recorded in the recording medium 105 according to the format and the like. The decoder 107 decodes the bit stream received from the playback separator 106, and outputs the results to the second encoder 108 as a decoded moving image signal. The second encoder 108 performs re-compression coding for the decoded moving image signal based on the input control information (V, Tr, Vi). The resultant moving image signal re-coded by the second encoder 108 is recorded in the recording medium (for example, a DVD-R) 109.

<Operation>

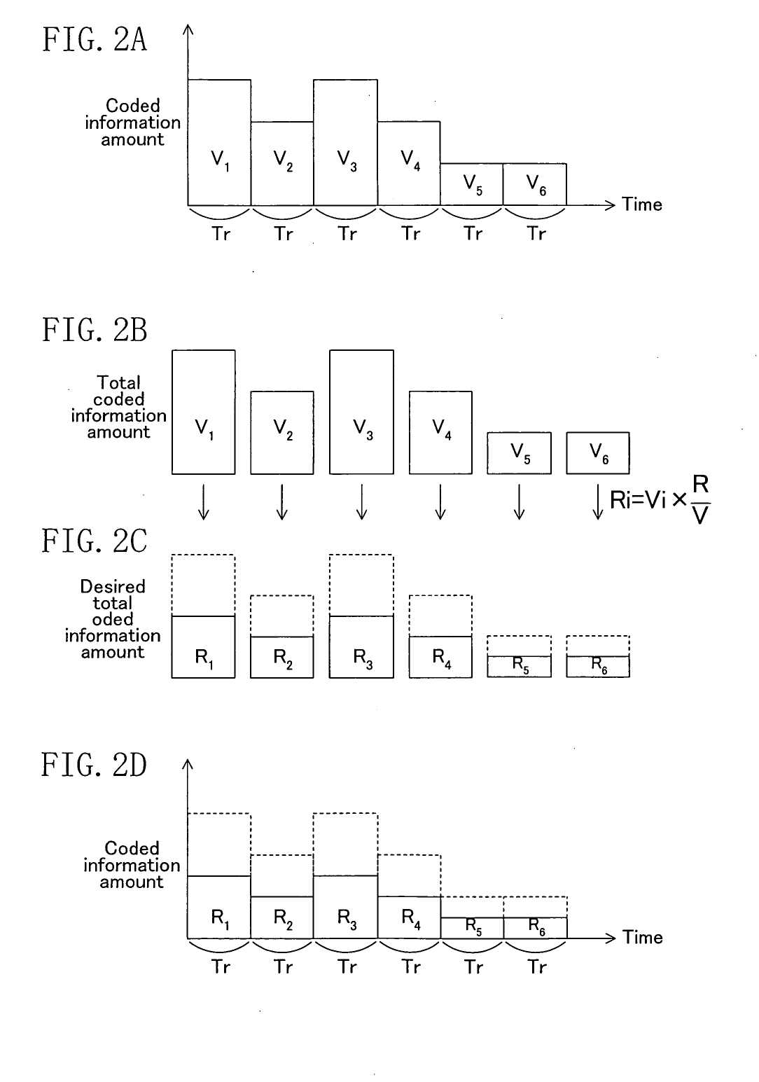

The operation of the moving image coding apparatus of FIG. 1 will be described with reference to FIGS. 2A to 2D.

The first encoder 101 compression-codes a moving image signal input every frame period to generate a coded moving image signal, and outputs the coded moving image signal to the data amount counter 102 and the recording multiplexer 104 in the form of a bit stream. In the compression coding, the first encoder 101 codes a moving image signal input in the total input time T into a coded moving image signal (bit stream) of the total coded information amount V For example, feedback coded amount control is performed during the compression coding so that the total coded information amount of the bit stream output from the first encoder 101 agrees with a target value (the total coded information amount V in this case).

The data counter 102 counts the coded information amount of the bit stream received from the first encoder 101, and outputs the counted results to the data increment calculator 103. For example, the data amount counter 102 starts counting the coded information amount when the first encoder 101 starts outputting a bit stream and continues counting until the output of the coded moving image signal terminates.

The data increment calculator 103 calculates the increment Vi of the coded information amount in each predetermined time interval Tr from the counted results received from the data amount counter 102, and outputs the calculated increment Vi of the coded information amount and the predetermined time interval Tr to the recording multiplexer 104. In other words, the data increment calculator 103 determines the coded information amount Vi of the coded moving image signal output from the first encoder 101 every predetermined time interval Tr. For example, the data increment calculator 103 receives the count value from the data amount counter 102 every predetermined time interval Tr, and calculates the difference between the currently received count value and the immediately previously received count value, to determine the increment Vi of the coded information amount. That is, the increment Vi of the coded information amount in each predetermined time interval Tr is determined as shown in FIG. 2A.

The recording multiplexer 104 multiplexes the bit stream output from the first encoder 101, the total coded information amount V of the bit stream output from the first encoder 101, and the predetermined time interval Tr and the increment Vi of the coded information amount output from the data increment calculator 103 in a form conforming to the format of the recording medium 105, and records the resultant data in the recording medium 105. For example, the recording multiplexer 104 records the bit stream in a continuous information recording area and records the control information such as the total coded information amount V of the bit stream, the predetermined time interval Tr and the increment Vi of the coded information amount in a management information area and the like defined in advance in the format.

The playback separator 106 plays back and separates necessary information from the recording medium 105 according to the format of the recording medium. 105, and outputs the bit stream to the decoder 107 and the control information such as the total coded information amount V of the bit stream, the predetermined time interval Tr and the increment Vi of the coded information amount to the second encoder 108.

The decoder 107 decodes the bit stream received from the playback separator 106, and outputs the results to the second encoder 108 as the decoded moving image signal.

The second encoder 108 externally receives a desired total coded information amount R for a bit stream to be generated after compression coding. The second encoder 109 compression-codes the decoded moving image signal received from the decoder 107 based on the desired total coded information amount R received externally, the total coded information amount V of the bit stream, the predetermined time interval Tr and the increment Vi of the coded information amount received from the playback separator 106. The second encoder 108 performs the compression coding based on the control information (R, V, Vi) so that a coded information amount Ri to be output every predetermined time interval Tr is a function of the control information (R, V, Vi). For example, the second encoder 108 determines the coded information amount Ri to be output every predetermined time interval Tr by performing proportional calculation of Vi×R/V The total coded information amount of the bit stream output from the second encoder 108 in the manner described above agrees with the desired total coded information amount R. That is, as shown in FIGS. 2A to 2D, the proportional calculation of Ri=Vi×RN is performed for the coded information amount Vi in each predetermined time interval Tr, to obtain the coded information amount Ri to be output every predetermined time interval Tr. Once all the calculated coded information amounts Ri have been output, this indicates that the coded moving image signal of the total coded information amount R has been output. In this embodiment, assume that the desired total coded information amount R is smaller than the total coded information amount V of the bit stream.

The moving image signal re-coded by the second encoder 108 is then recorded in the recording medium (for example, a DVD-R) 109.

<Effect>

As described above, it is possible to control the coded information amount over the entire decoded moving image signal, for which the compression coding (second coding) is to be performed by the second encoder 108, using the information on the compression coding generated during the compression coding (first coding) by the first encoder 101. Moreover, in this embodiment, since the desired total coded information amount R is smaller than the total coded information amount V output from the first encoder 101, the total coded information amount of the coded moving image signal can be reduced.

The increment Vi of the coded information amount indicates the degree of difficulty of coding of the input moving image signal, in which the degree of difficulty is higher (the coding is more difficult) as the value is larger. Therefore, the coded information amount Ri to be output every predetermined time interval Tr, which is determined by the proportional calculation (Ri=Vi×R/V) described above, is large when the degree of difficulty of coding is high, and is small when it is low. In this way, by controlling the coded information amount every local time interval while considering the degree of difficulty of coding in the second coding, it is possible to attain the second coding close to the first coding.

Also, even if the performance of the second encoder 108 on the control of the coded information amount is somewhat inferior to that of the first encoder 101, the second encoder 108 can perform control conforming to the performance of the first encoder 101 on the control of the coded information amount.

Although the recording medium 105 is embedded in the moving image coding apparatus in this embodiment, it may be provided externally. The reason why the recording medium 105 is used in this embodiment is that the recording multiplexer 104 can write the bit stream and the control information in separate areas of the recording medium 105 in recording of the data, and this facilitates the separation (extraction of necessary data) by the playback separator 106.

The predetermined time interval Tr in this embodiment may be set in advance, or may be set externally.

The predetermined time interval Tr in this embodiment is preferably 0.5 sec or more.

In this embodiment, it was assumed that the desired total coded information amount R was smaller than the total coded information amount V of the bit stream. The control of the coded information amount over the entire decoded moving image signal to be coded can also be performed when the desired total coded information amount R is equal to the total coded information amount of the bit stream.

(Embodiment 2)

<Overall Configuration>

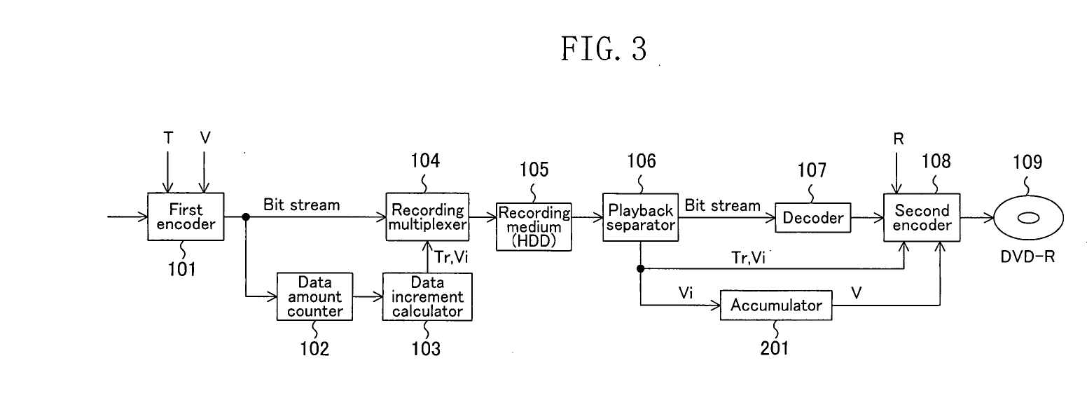

FIG. 3 shows the overall configuration of a moving image coding apparatus of Embodiment 2 of the present invention. The apparatus of this embodiment includes an accumulator 201 in addition to the components in Embodiment 1. The accumulator 201 accumulates the increment Vi of the coded information amount received from the playback separator 106, to determine the total amount (total coded information amount V of the bit stream).

<Operation>

The operation of the moving image coding apparatus of FIG. 3 will be described.

The first encoder 101 compression-codes a moving image signal input every frame period to generate a coded moving image signal, and outputs the coded moving image signal to the data amount counter 102 and the recording multiplexer 104 in the form of a bit stream. In the compression coding, the first encoder 101 codes a moving image signal input in a total input time T into a coded moving image signal (bit stream) of a total coded information amount V.

The data counter 102 counts the coded information amount of the bit stream received from the first encoder 101, and outputs the counted results to the data increment calculator 103.

The data increment calculator 103 calculates the increment Vi of the coded information amount in each predetermined time interval Tr from the input counted results, and outputs the calculated increment Vi of the coded information amount and the predetermined time interval Tr to the recording multiplexer 104.

The recording multiplexer 104 multiplexes the bit stream output from the first encoder 101, the predetermined time interval Tr and the increment Vi of the coded information amount output from the data increment calculator 103 into a form conforming to the format of the recording medium 105, and records the resultant data in the recording medium 105. For example, the recording multiplexer 104 records the bit stream in a continuous information recording area, and records the control information such as the predetermined time interval Tr and the increment Vi of the coded information amount in a management information area and the like defined in advance in the format.

The playback separator 106 plays back and separates necessary information from the recording medium 105 according to the format of the recording medium 105, and outputs the bit stream to the decoder 107 and the control information such as the predetermined time interval Tr and the increment Vi of the coded information amount to the second encoder 108. The playback separator 106 also outputs the increment Vi of the coded information amount to the accumulator 201.

The accumulator 201 accumulates the increment Vi of the coded information amount received from the playback separator 106 to calculate the total amount (that is, the total coded information amount V of the bit stream). The accumulator 201 outputs the resultant total coded information amount V of the bit stream to the second encoder 108.

The decoder 107 decodes the bit stream received from the playback separator 106, and outputs the results to the second encoder 108 as the decoded moving image signal.

The second encoder 108 receives a desired total coded information amount R for a bit stream to be generated after compression coding. The second encoder 108 codes the decoded moving image signal received from the decoder 107 based on the desired total coded information amount R received externally, the predetermined time interval Tr and the increment Vi of the coded information amount received from the playback separator 106, and the total coded information amount V of the bit stream received from the accumulator 201. The second encoder 108 performs the compression coding based on the control information (R, V, vi) so that a coded information amount Ri to be output every predetermined time interval Tr is a function of the control information (R, V, Vi). For example, the second encoder 108 determines the coded information amount Ri to be output every predetermined time interval Tr by performing the proportional calculation of Vi×R/V. The total coded information amount of the bit stream output from the second encoder 108 in the manner described above agrees with the desired total coded information amount R. In this embodiment, assume that the desired total coded information amount R is smaller than the total coded information amount V of the bit stream.

The moving image signal re-coded by the second encoder 108 is then recorded in the recording medium (for example, a DVD-R) 109.

<Effect>

As described above, it is possible to control the coded information amount over the entire decoded moving image signal, for which the compression coding (second coding) is to be performed by the second encoder 108, using information on the compression coding generated during the compression coding (first coding) by the first encoder 101. Moreover, in this embodiment, since the desired total coded information amount R is smaller than the total coded information amount V output from the first encoder 101, the total coded information amount of the coded moving image signal can be reduced.

The increment Vi of the coded information amount indicates the degree of difficulty of coding of the input moving image signal, in which the degree of difficulty is higher (the coding is more difficult) as the value is larger. Therefore, the coded information amount Ri to be output every predetermined time interval Tr, which is determined by the proportional calculation (Ri=Vi×R/V) described above, is large when the degree of difficulty of coding is high, and is small when it is low. In this way, by controlling the coded information amount every local time interval while considering the 25 degree of difficulty of coding in the second coding, it is possible to attain the second coding close to the first coding.

Also, even if the performance of the second encoder 108 on the control of the coded information amount is somewhat inferior to that of the first encoder 101, the second encoder 108 can perform control conforming to the performance of the first encoder 101 on the control of the coded information amount.

In this embodiment, in which the accumulator 201 calculates the total coded information amount V of the bit stream, the amount of information recorded in the recording medium 105 as the control information can be reduced, compared with that in Embodiment 1.

In this embodiment, it was assumed that the desired total coded information amount R was smaller than the total coded information amount V of the bit stream. The control of the coded information amount over the entire decoded moving image signal to be coded can also be performed when the desired total coded information amount R is equal to the total coded information amount of the bit stream.

(Embodiment 3)

<Overall Configuration>

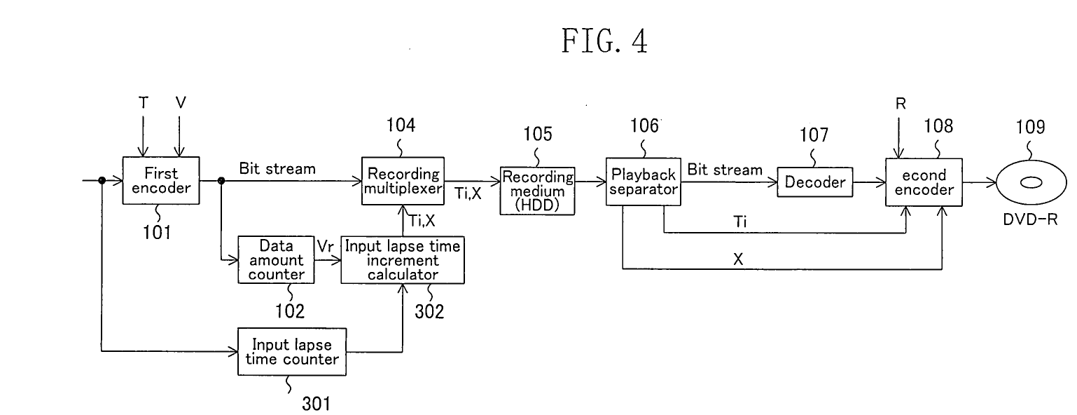

FIG. 4 shows the overall configuration of a moving image coding apparatus of Embodiment 3 of the present invention. The apparatus of this embodiment includes an input lapse time counter 301 and an input lapse time increment calculator 302 in place of the data increment calculator 103 in the configuration in Embodiment 1. The input lapse time counter 301 counts the lapse time of input of a moving image signal. The data amount counter 102 counts the coded information amount of a bit stream received from the first encoder 101, and outputs an increment detection signal to the input lapse time increment calculator 302 every time the increment of the information amount reaches a predetermined amount Vr. The input lapse time increment calculator 302 calculates an increment Ti of the input lapse time based on the increment detection signal received from the data amount counter 102 and the counted results of input lapse time counter 301.

<Operation>

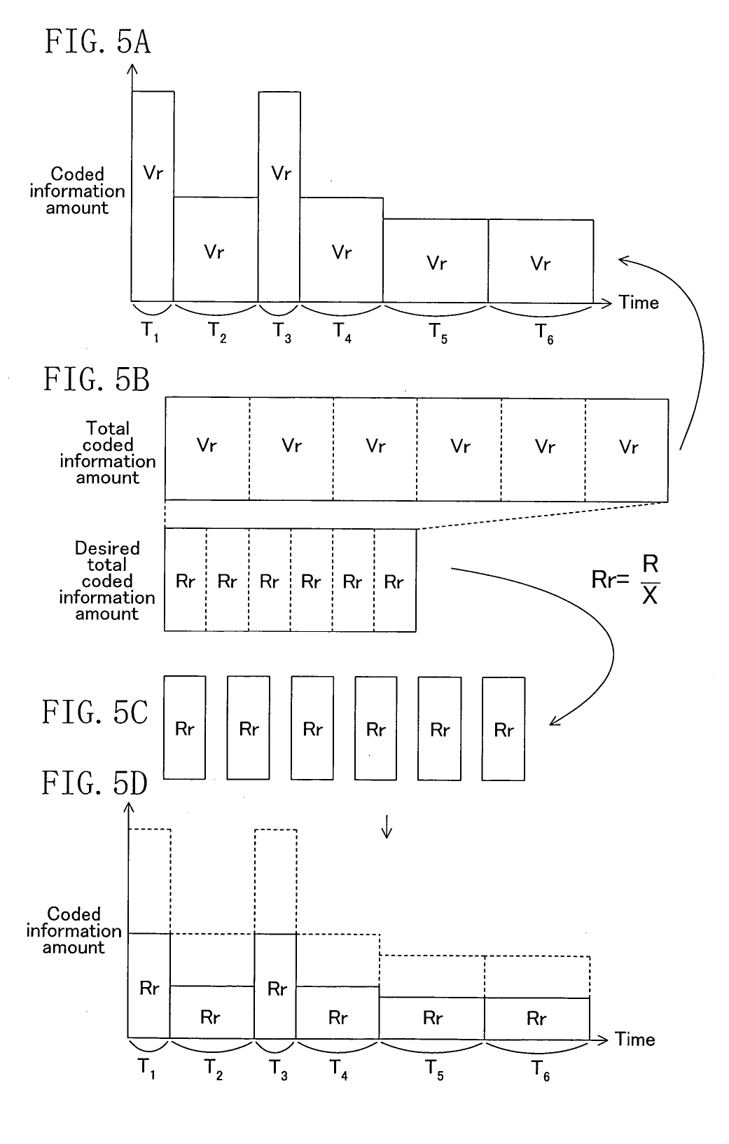

The operation of the moving image coding apparatus of FIG. 4 will be described with reference to FIG. 5.

The first encoder 101 compression-codes a moving image signal input every frame period to generate a coded moving image signal, and outputs the coded moving image signal to the data amount counter 102 and the recording multiplexer 104 in the form of a bit stream. In the compression coding, the first encoder 101 codes a moving image signal input in a total input time T into a coded moving image signal (bit stream) of a total coded information amount V.

The input lapse time counter 301 counts the lapse time of input of the moving image signal into the first encoder 101. For example, the input lapse time counter 301 starts counting once a moving image signal is input into the first encoder 101 and continues counting until the input of the moving image signal is terminated.

The data counter 102 counts the increment of the coded information amount of the bit stream received from the first encoder 101, and outputs the increment detection signal to the input lapse time increment calculator 302 every time the increment reaches the predetermined amount Vr.

The input lapse time increment calculator 302 calculates the increment Ti of the input lapse time every time the increment of the coded information amount reaches the predetermined value Vr based on the count value of the input lapse time counter 301 and the increment detection signal output from the data amount counter 102, and outputs the calculated increment Ti of the input lapse time to the recording multiplexer 104. For example, the input lapse time increment calculator 302 receives the count value of the input lapse time counter 301 at the time of input of the increment detection signal, and calculates the difference between the currently received count value and the immediately previously received count value, to determine the increment Ti of the input lapse time. The input lapse time increment calculator 302 also calculates the number of increments Ti of the input lapse time. For example, the input lapse time increment calculator 302 counts the increment detection signal output from the data amount counter 102, to determine the number X of increments Ti of the input lapse time. That is, the increment Ti of the input lapse time in each predetermined increment Vr of the coded information amount is determined as shown in FIG. 5A.

The recording multiplexer 104 multiplexes the bit stream output from the first encoder 101, the increment Ti of the input lapse time and the number X of increments output from the input lapse time increment calculator 302 in a form conforming to the format of the recording medium 105, and records the resultant data in the recording medium 105. For example, the bit stream is recorded in a continuous information recording area, and the control information such as the total input time T, the increment Ti of the input lapse time and the number X of increments is recorded in a management information area and the like defined in advance in the format.

The playback separator 106 plays back and separates necessary information from the recording medium 105 according to the format of the recording medium 105, and outputs the bit stream to the decoder 107 and the control information such as the increment Ti of the input lapse time and the number X of increments to the second encoder 108.

The decoder 107 decodes the bit stream received from the playback separator 106, and outputs the results to the second encoder 108 as the decoded moving image signal.

The second encoder 108 externally receives a desired total coded information amount R for a bit stream to be generated after compression coding. The second encoder 108 codes the decoded moving image signal received from the decoder 107 based on the desired total coded information amount R received externally and the increment Ti of the input lapse time and the number X of increments received from the playback separator 106. The second encoder 108 performs the compression coding based on the control information (R, Ti, X) so that a coded information amount Rr to be output every increment Ti of the input lapse time is a function of R and X. For example, the second encoder 108 determines the coded information amount Rr to be output every increment Ti of the input lapse time by calculating R/X. The total coded information amount of the bit stream output from the second encoder 108 in the manner described above agrees with the desired total coded information amount R. That is, as shown in FIGS. 5A to 5D, the desired total coded information amount R is divided by the number X of increments Ti of the input lapse time (Rr=R/X), to determine the coded information amount Rr to be output in each increment Ti of the input lapse time. Once all the calculated coded information amounts Rr are output, this indicates that the coded moving image signal of the total coded information amount R has been output. In this embodiment, assume that the desired total coded information amount R is smaller than the total coded information amount V.

The moving image signal re-coded by the second encoder 108 is then recorded in the recording medium (for example, a DVD-R) 109.

<Effect>

As described above, it is possible to control the coded information amount over the entire decoded moving image signal, for which the compression coding (second coding) is to be performed by the second encoder 108, using information on the compression coding generated during the compression coding (first coding) by the first encoder 101. Moreover, in this embodiment, since the desired total coded information amount R is smaller than the total coded information amount V output from the first encoder 101, the total coded information amount of the coded moving image signal can be reduced.

The increment Ti of the input lapse time indicates the degree of difficulty of coding of the input moving image signal, in which the degree of difficulty is higher (the coding is more difficult) as the value is smaller. Therefore, the time Ti for which the fixed coded information amount Rr is allocated is short when the degree of difficulty of coding is high, and is long when it is low. In this way, by controlling the coded information amount while considering the degree of difficulty of coding in the second coding, it is possible to attain the second coding close to the first coding.

Also, even if the performance of the second encoder 108 on the control of the coded information amount is somewhat inferior to that of the first encoder 101, the second encoder 108 can perform control conforming to the performance of the first encoder 101 on the control of the coded information amount.

In this embodiment, it was assumed that the desired total coded information amount R was smaller than the total coded information amount V of the bit stream. The control of the coded information amount over the entire decoded moving image signal to be coded can also be performed when the desired total coded information amount R is equal to the total coded information amount of the bit stream.

(Embodiment 4)

<Overall Configuration>

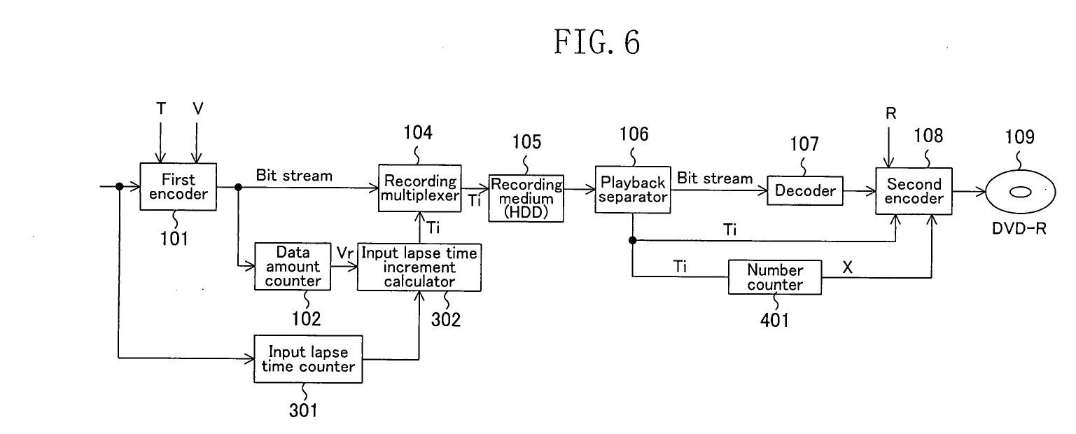

FIG. 6 shows the overall configuration of a moving image coding apparatus of Embodiment 4 of the present invention. The apparatus of this embodiment includes a number counter 401 in addition to the components in Embodiment 3. The number counter 401 counts the number X of increments Ti of the input lapse time received from the playback separator 106.

<Operation>

The operation of the moving image coding apparatus of FIG. 6 will be described.

The first encoder 101 compression-codes a moving image signal input every frame period to generate a coded moving image signal, and outputs the coded moving image signal to the data amount counter 102 and the recording multiplexer 104 in the form of a bit stream. In the compression coding, the first encoder 101 codes a moving image signal input in the total input time T into a coded moving image signal (bit stream) of a total coded information amount V.

The input lapse time counter 301 counts the lapse time of input of the moving image signal into the first encoder 101.

The data amount counter 102 counts an increment of the coded information amount of the bit stream received from the first encoder 101, and outputs an increment detection signal to the input lapse time increment calculator 302 every time the increment reaches a predetermined amount Vr.

The input lapse time increment calculator 302 calculates an increment Ti of the input lapse time every time the increment of the coded information amount reaches the predetermined value Vr based on the count value of the input lapse time counter 301 and the increment detection signal output from the data amount counter 102, and outputs the calculated increment Ti of the input lapse time to the recording multiplexer 104.

The recording multiplexer 104 multiplexes the bit stream received from the first encoder 101 and the increment Ti of the input lapse time received from the input lapse time increment calculator 302 in a form conforming to the format of the recording medium 105, and records the resultant data in the recording medium 105. For example, the bit stream is recorded in a continuous information recording area, and the control information such as the increment Ti of the input lapse time is recorded in a management information area and the like defined in advance in the format.

The playback separator 106 plays back and separates necessary information from the recording medium 105 according to the format of the recording medium 1.05, and outputs the bit stream to the decoder 107 and the control information such as the increment Ti of the input lapse time to the second encoder 108 and the number counter 401.

The number counter 401 counts the number X of increments Ti of the input lapse time received from the playback separator 106. The number counter 401 outputs the number X obtained by the counting to the second encoder 108.

The decoder 107 decodes the bit stream received from the playback separator 106, and outputs the results to the second encoder 108 as the decoded moving image signal.

The second encoder 108 externally receives a desired total coded information amount R for a bit stream to be generated after compression coding. The second encoder 108 codes the decoded moving image signal received from the decoder 107 based on the desired total coded information amount R received externally, the increment Ti of the input lapse time received from the playback separator 106, and the number X of increments received from the number counter 401. The second encoder 108 performs the compression coding based on the control information (R, Ti, X) so that a coded information amount Rr to be output every increment Ti of the input lapse time is a function of R and X. For example, the second encoder 108 determines the coded information amount Rr to be output every increment Ti of the input lapse time by calculating R/X. The total coded information amount of the bit stream output from the second encoder 108 in the manner described above agrees with the desired total coded information amount R. In this embodiment, assume that the desired total coded information amount R is smaller than the total coded information amount V.

The moving image signal re-coded by the second encoder 108 is then recorded in the recording medium (for example, a DVD-R) 109.

<Effect>

As described above, it is possible to control the coded information amount over the entire decoded moving image signal, for which the compression coding (second coding) is to be performed by the second encoder 108, using information on the compression coding generated during the compression coding (first coding) by the first encoder 101. Moreover, in this embodiment, since the desired total coded information amount R is smaller than the total coded information amount V output from the first encoder 101, the total coded information amount of the coded moving image signal can be reduced.

The increment Ti of the input lapse time indicates the degree of difficulty of coding of the input moving image signal, in which the degree of difficulty is higher (the coding is more difficult) as the value is smaller. Therefore, the time Ti for which the fixed coded information amount Rr is allocated is short when the degree of difficulty of coding is high, and is long when it is low. In this way, by controlling the coded information amount while considering the degree of difficulty of coding in the second coding, it is possible to attain the second coding close to the first coding.

Also, even if the performance of the second encoder 108 on the control of the coded information amount is somewhat inferior to that of the first encoder 101, the second encoder 108 can perform control conforming to the performance of the first encoder 101 on the control of the coded information amount.

In this embodiment, in which the number X of increments Ti of the input lapse time is counted by the number counter 401, the amount of information recorded in the recording medium 105 as the control information can be reduced, compared with that in Embodiment 1.

In this embodiment, it was assumed that the desired total coded information amount R was smaller than the total coded information amount V of the bit stream. The control of the coded information amount over the entire decoded moving image signal to be coded can also be performed when the desired total coded information amount R is equal to the total coded information amount of the bit stream.

The moving image coding apparatus of the present invention is suitable for cases such as the case of compression-coding a moving image signal once compression-coded and recorded in a temporary recording medium such as a HDD and recording the coded moving image signal in a recording medium for storage such as a DVD-R.

While the present invention has been described in preferred embodiments, it will be apparent to those skilled in the art that the disclosed invention may be modified in numerous ways and may assume many embodiments other than that specifically set out and described above. Accordingly, it is intended by the appended claims to cover all modifications of the invention which fall within the true spirit and scope of the invention.

1. A moving image coding apparatus comprising:
a first coding section for compression-coding a moving image signal in a first time (T) and outputting the results as a coded moving image signal of a first information amount (V), and also obtaining control information;
a decoding section for decoding the coded moving image signal compression-coded by the first coding section and outputting the results as a decoded moving image signal; and
a second coding section for compression-coding the decoded moving image signal from the decoding section based on the control information obtained by the first coding section and a set second information amount (R) and outputting the results as a coded moving image signal of the second information amount (R),
wherein the control information includes:
the first information amount (V);
a plurality of second times (Try obtained by dividing the first time (T); and
a third information amount (Vi) as the information amount of a coded moving image signal output from the first coding section during each of the plurality of second times (Tr).

2. The moving image coding apparatus of claim 1, wherein the first coding section includes:
a third coding section for compression-coding the moving image signal in the first time (T) and outputting the results as the coded moving image signal of the first information amount (V), and also obtaining the second time (Tr) and the third information amount (Vi); and
a total coded amount calculation section for calculating the first information amount (V) using the third information amount (Vi) obtained by the third coding section, and
the second coding section compression-codes the decoded moving image signal from the decoding section based on the second time (Tr) and the third information amount (Vi) obtained by the third coding section, the first information amount (V) obtained by the total coded amount calculation section, and the set second information amount (R), and outputs the results as the coded moving image signal of the second information amount (R).

3. The moving image coding apparatus of claim 1, wherein the second coding section outputs a coded moving image signal of a fourth information amount (Ri) during each of the plurality of second times (Tr), and
the fourth information amount (Ri) is obtained by calculating
Ri=Vi×R/V
using the first information amount (V), the second information amount (R) and the third information amount (Vi).

4. A moving image coding apparatus comprising:
a first coding section for compression-coding a moving image signal in a first time (T) and outputting the results as a coded moving image signal of a first information amount (V), and also obtaining control information;
a decoding section for decoding the coded moving image signal compression-coded by the first coding section and outputting the results as a decoded moving image signal; and
a second coding section for compression-coding the decoded moving image signal from the decoding section based on the control information obtained by the first coding section and a set second information amount (R) and outputting the results as a coded moving image signal of the second information amount (R),
wherein the control information includes:
a plurality of second times (Ti); and
a number (X) of the second times (Ti),
the plurality of second times (Ti) correspond to a plurality of third information amounts (Vr) obtained by dividing the first information amount (V), and
each of the plurality of second times (Ti) represents the time required for a coded moving image signal of the corresponding third information amount (Vr) to be output from the first coding section.

5. The moving image coding apparatus of claim 4, wherein the second coding section includes:
a third coding section for compression-coding the moving image signal in the first time (T) and outputting the results as the coded moving image signal of the first information amount (V), and also obtaining the second time (Ti); and
a number count section for counting the number (X) of the second times (Ti) obtained by the third coding section, and
the second coding section compression-codes the decoded moving image signal from the decoding section based on the second time (Ti) obtained by the third coding section, the number (X) obtained by the number count section, and the set second information amount (R), and outputs the results as the coded moving image signal of the second information amount (R).

6. The moving image coding apparatus of claim 4, wherein the second coding section outputs a coded moving image signal of a fourth information amount (Rr) during each of the plurality of second times (Ti), and
the fourth information amount (Rr) is obtained by calculating
Rr=R/X
using the number (X) and the second information amount (R).

7. A moving image coding apparatus comprising:
a first coding section for compression-coding a moving image signal in a first time (T) and outputting the results as a coded moving image signal of a first information amount (V), and also obtaining control information,
wherein the control information includes:
a plurality of second times (Tr) obtained by dividing the first time (T); and
a third information amount (Vi) as the information amount of a coded moving image signal output from the first coding section during each of the plurality of second times (Tr).

8. A moving image coding apparatus for processing a signal including a compression-coded moving image signal (coded moving image signal) and control information,
wherein the coded moving image signal is obtained by compression-coding a moving image signal in a first time (T) to give a first information amount (V),
the control information includes:
the first information amount (V) of the coded moving image signal;
a plurality of second times (Tr) obtained by dividing the first time (T); and
a third information amount (Vi) as the information amount of a moving image signal output during each of the plurality of second times (Tr) in the compression coding of the coded moving image signal, and
the apparatus comprises:
a decoding section for decoding the coded moving image signal and outputting the results as a decoded moving image signal; and
a second coding section for compression-coding the decoded moving image signal from the decoding section based on the control information and a set second information amount (R) and outputting the results as a coded moving image signal of the second information amount (R).

9. A moving image coding apparatus comprising:
a first coding section for compression-coding a moving image signal in a first time (T) and outputting the results as a coded moving image signal of a first information amount (V), and also obtaining control information,
wherein the control information includes a plurality of second times (Ti),
the plurality of second times (Ti) correspond to a plurality of third information amounts (Vr) obtained by dividing the first information amount (V), and
each of the plurality of second times (Ti) represents the time required for a coded moving image signal of the corresponding third information amount (Vr) to be output from the first coding section.

10. A moving image coding apparatus for processing a signal including a compression-coded moving image signal (coded moving image signal) and control information,
wherein the coded moving image signal is obtained by compression-coding a moving image signal in a first time (T) to give a first information amount (V),
the control information includes:
a plurality of second times (Ti); and
a number (X) of the second times (Ti),
the plurality of second times (Ti) correspond to a plurality of third information amounts (Vr) obtained by dividing the first information amount (V),
each of the plurality of second times (Ti) represents the time required for a coded moving image signal of the corresponding third information amount (Vr) to be output in the compression coding of the coded moving image signal, and
the apparatus comprises:
a decoding section for decoding the coded moving image signal and outputting the results as a decoded moving image signal; and
a second coding section for compression-coding the decoded moving image signal from the decoding section based on the control information and a set second information amount (R) and outputting the results as a coded moving image signal of the second information amount (R).

11. The moving image coding apparatus of claim 1, wherein the second information amount (R) is smaller than the first information amount (V).

12. The moving image coding apparatus of claim 4, wherein the second information amount (R) is smaller than the first information amount (V).

13. The moving image coding apparatus of claim 8, wherein the second information amount (R) is smaller than the first information amount (V).

14. The moving image coding apparatus of claim 10, wherein the second information amount (R) is smaller than the first information amount (V).

15. A moving image coding method comprising:
a first coding step of compression-coding a moving image signal in a first time (T) and outputting the results as a coded moving image signal of a first information amount (V), and also obtaining control information;
a decoding step of decoding the coded moving image signal compression-coded in the first coding step and outputting the results as a decoded moving image signal; and
a second coding step of compression-coding the decoded moving image signal obtained in the decoding step based on the control information obtained in the first coding step and a set second information amount (R) and outputting the results as a coded moving image signal of the second information amount (R),
wherein the control information includes:
the first information amount (V);
a plurality of second times (Tr) obtained by dividing the first time (T); and
a third information amount (Vi) as the information amount of a coded moving image signal output in the first coding step during each of the plurality of second times (Tr).

16. The moving image coding method of claim 15, wherein the first coding step includes:
a third coding step of compression-coding the moving image signal in the first time (T) and outputting the results as the coded moving image signal of the first information amount (V), and also obtaining the second time (Tr) and the third information amount (Vi); and
a total coded amount calculation step of calculating the first information amount (V) using the third information amount (Vi) obtained in the third coding step, and
in the second coding step, the decoded moving image signal obtained in the decoding step is compression-coded based on the second time (Tr) and the third information amount (Vi) obtained in the third coding step, the first information amount (V) obtained in the total coded amount calculation step, and the set second information amount (R), and the results are output as the coded moving image signal of the second information amount (R).

17. The moving image coding method of claim 15, wherein in the second coding step, a coded moving image signal of a fourth information amount (Ri) is output during each of the plurality of second times (Tr), and
the fourth information amount (Ri) is obtained by calculating
Ri=Vi×R/V
using the first information amount (V), the second information amount (R) and the third information amount (Vi).

18. A moving image coding method comprising:
a first coding step of compression-coding a moving image signal in a first time (T) and outputting the results as a coded moving image signal of a first information amount (V), and also obtaining control information;
a decoding step of decoding the coded moving image signal compression-coded in the first coding step and outputting the results as a decoded moving image signal; and
a second coding step of compression-coding the decoded moving image signal obtained in the decoding step based on the control information obtained in the first coding step and a set second information amount (R) and outputting the results as a coded moving image signal of the second information amount (R),
wherein the control information includes:
a plurality of second times (Ti); and
a number (X) of the second times (Ti),
the plurality of second times (Ti) correspond to a plurality of third information amounts (Vr) obtained by dividing the first information amount (V), and
each of the plurality of second times (Ti) represents the time required for a coded moving image signal of the corresponding third information amount (Vr) to be output in the first coding step.

19. The moving image coding method of claim 18, wherein the second coding step includes:
a third coding step of compression-coding a moving image signal in the first time (T) and outputting the results as the coded moving image signal of the first information amount (V), and also obtaining the second time (Ti); and
a number count step of counting the number (X) of the second times (Ti) obtained in the third coding step, and
in the second coding step, the decoded moving image signal obtained in the second coding step is compression-coded based on the second time (Ti) obtained in the third coding step, the number (X) obtained in the number count step, and the set second information amount (R), and the results are output as the coded moving image signal of the second information amount (R).

20. The moving image coding method of claim 18, wherein in the second coding step, a coded moving image signal of a fourth information amount (Rr) is output during each of the plurality of second times (Ti), and
the fourth information amount (Rr) is obtained by calculating
Rr=R/X
using the number (X) and the second information amount (R).

21. A moving image coding method comprising:
a first coding step of compression-coding a moving image signal in a first time (T) and outputting the results as a coded moving image signal of a first information amount (V), and also obtaining control information,
wherein the control information includes:
a plurality of second times (Tr) obtained by dividing the first time (T); and
a third information amount (Vi) as the information amount of a coded moving image signal output in the first coding step during each of the plurality of second times (Tr).

22. A moving image coding method for processing a signal including a compression-coded moving image signal (coded moving image signal) and control information,
wherein the coded moving image signal is obtained by compression-coding a moving image signal in a first time (T) to give a first information amount (V),
the control information includes:
the first information amount (V) of the coded moving image signal;
a plurality of second times (Tr) obtained by dividing the first time (T); and
a third information amount (Vi) as the information amount of a moving image signal output during each of the plurality of second times (Tr) in the compression coding of the coded moving image signal, and
the method comprises:
a decoding step of decoding the coded moving image signal and outputting the results as a decoded moving image signal; and
a second coding step of compression-coding the decoded moving image signal obtained in the decoding step based on the control information and a set second information amount (R) and outputting the results as a coded moving image signal of the second information amount (R).

23. A moving image coding method comprising:
a first coding step of compression-coding a moving image signal in a first time (T) and outputting the results as a coded moving image signal of a first information amount (V), and also obtaining control information,
wherein the control information includes a plurality of second times (Tr),
the plurality of second times (Ti) correspond to a plurality of third information amount (Vr) obtained by dividing the first information amount (V), and
each of the plurality of second times (Ti) represents the time required for a coded moving image signal of the corresponding third information amount (Vr) to be output in the first coding step.

24. A moving image coding method for processing a signal including a compression-coded moving image signal (coded moving image signal) and control information,
wherein the coded moving image signal is obtained by compression-coding a moving image signal in a first time (T) to give a first information amount (V),
the control information includes:
a plurality of second times (Ti); and
a number (X) of the second times (Ti),
the plurality of second times (Ti) correspond to a plurality of third information amounts (Vr) obtained by dividing the first information amount (V),
each of the plurality of second times (Ti) represents the time required for a coded moving image signal of the corresponding third information amount (Vr) to be output in the compression coding of the coded moving image signal, and
the method comprises:
a decoding step of decoding the coded moving image signal and outputting the results as a decoded moving image signal; and
a second coding step of compression-coding the decoded moving image signal obtained in the decoding step based on the control information and a set second information amount (R) and outputting the results as a coded moving image signal of the second information amount (R).

25. The moving image coding method of claim 15, wherein the second information amount (R) is smaller than the first information amount (V).

26. The moving image coding method of claim 18, wherein the second information amount (R) is smaller than the first information amount (V).

27. The moving image coding method of claim 22, wherein the second information amount (R) is smaller than the first information amount (V).

28. The moving image coding method of claim 24, wherein the second information amount (R) is smaller than the first information amount (V).
